(19) United States
(12) Patent Application Publication
(10) Pub. No.: US 2008/0055316 A1
(43) Pub. Date: Mar. 6, 2008

(54) Programmatically representing sentence meaning with animation

(75) Inventors: Michel Pahud, Kirkland, WA (US); Howard W. Phillips, Woodinville, WA (US)

Correspondence Address: MICROSOFT CORPORATION, ONE MICROSOFT WAY, REDMOND, WA, 98052-6399, US

(73) Assignee: Microsoft Corporation, Redwood, WA (US)

(21) Appl. No.: 11/512,652

(22) Filed: Aug. 30, 2006

(51) Int. Cl. G06T 13/00

(52) U.S. Cl. 345/473

(57) ABSTRACT

Various technologies and techniques are disclosed for programmatically representing sentence meaning. Metadata is retrieved for an actor, the actor representing a noun to be in a scene. At least one image is also retrieved for the actor and displayed on the background. An action representing a verb for the actor to perform is retrieved. The at least one image of the actor is displayed with a modified behavior that is associated with the action and modified based on the actor metadata. If there is a patient representing another noun in the scene, then patient metadata and at least one patient image are retrieved. The at least one patient image is then displayed. When the patient is present, the modified behavior of the actor can be performed against the patient. The nouns and/or verbs can be customized by a content author.

### BACKGROUND

Individually authoring graphic and sound representations of sentence meaning is time consuming, and can be very costly. The number of unique subject-object (i.e. actor/patient) pairs is equal to the square of the number of nouns (i.e. 100 nouns=10,000 unique pairs). Similarly, individually authoring animations for each subject-verb-object combination is even more time consuming. For example, if you have the verb kick and want to represent it in animations with the nouns boy, mouse, and elephant, there are nine possible sentences that can result (e.g. boy kicks mouse, mouse kicks boy, elephant kicks boy, etc.). In a system using dozens if not hundreds of animations, to author unique subject-object pair animations or unique subject-verb-object animations is prohibitive.

### SUMMARY

Various technologies and techniques are disclosed for programmatically representing sentence meaning by converting text to animation. A background image (e.g. static image or animation) is retrieved for a scene. Metadata is retrieved for an actor, the actor representing a noun to be in the scene. At least one image (e.g. static image or animation) is also retrieved for the actor and displayed on the background. An action representing a verb for the actor to perform is retrieved. The at least one image of the actor is displayed with a modified behavior that is associated with the action and modified based on the actor metadata. If there is a patient representing another noun in the scene, then patient metadata and at least one patient image (e.g. static image or animation) are retrieved. The at least one patient image is then displayed. When the patient is present, the modified behavior of the actor can be performed against the patient, such as to represent something the actor is doing or saying to the patient. A patient action modified based upon the patient metadata can be performed against the actor in response to the action performed against the patient by the actor.

In one implementation, the nouns and/or verbs can be customized by a content author, such as by using a textual scripting language to create or modify one or more files used by the animation application.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a surprising animation application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in calculating the position and behavior of the image(s) for the actor and/or patient.

FIG. 5 is a process flow diagram for one implementation of the system of FIG. 1 illustrating the stages involved in providing a customizable animation system that allows a user to create and/or modify nouns and/or verbs.

FIG. 6 is a simulated screen for one implementation of the system of FIG. 1 that illustrates a programmatically generated animation to represent sentence meaning.

FIG. 7 is a logical diagram representing actor characteristics, and indicating how the images for an actor and/or patient are represented in one implementation prior to application of any movement.

FIG. 8 is a logical diagram representing actor animation characteristics, and indicating how the images for the actor and/or patient are represented in one implementation to apply movement.

FIG. 9 is a logical diagram representing metadata characteristics, showing some exemplary metadata values that could be used to describe an actor and/or patient in one implementation.

FIG. 10 is a logical diagram representing metadata formulas characteristics, and indicating some exemplary formulas that are based upon particular macro-actions and modified by metadata of an actor and/or patient in one implementation.

FIG. 11 is a logical diagram representing how a scene is constructed from component parts in one implementation.

FIG. 12 is a logical diagram with a corresponding flow diagram to walk through the stages of constructing a scene from component parts in one implementation.

FIG. 13 is a logical diagram representing a simplified example of some exemplary macro-actions to describe an exemplary action “kick”.

FIG. 14 is a logical diagram representing some exemplary action authoring guidelines with examples for different actions.

FIG. 15 is a logical diagram representing some exemplary action authoring guidelines with examples of variations for an exemplary kick action.

FIG. 16 is a logical diagram representing a hypothetical selection of actions for the actor and patient based on metadata.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an animation application that converts text to surprising animation programmatically, but the system also serves other purposes in addition to these. In one implementation, one or more of the techniques described herein can be implemented as features within an educational animation program such as, one creating a motivator for teaching a child or adult sentence meaning, or from any other type of program or service that uses animations with sentences. The term actor as used in the examples herein is meant to include a noun being represented in a sentence that is performing some action, and the term patient as used herein is meant to include a noun receiving the action. A noun that represents a patient in one scene may become an actor in a later scene if that noun then becomes the noun performing the main action. Any features described with respect to the actor and/or the patient can also be used with the other when appropriate, as the term is just used for conceptual illustration only. Furthermore, it will also be appreciated that multiple actors, multiple patients, single actors, single patients, and/or various combinations of actors and/or patients could be used in a given scene using the techniques discussed herein. Alternatively or additionally, it will also be appreciated that while nouns and verbs are used in the examples described herein, adjectives, adverbs, and/or other types of sentence structure can be used in the animations.

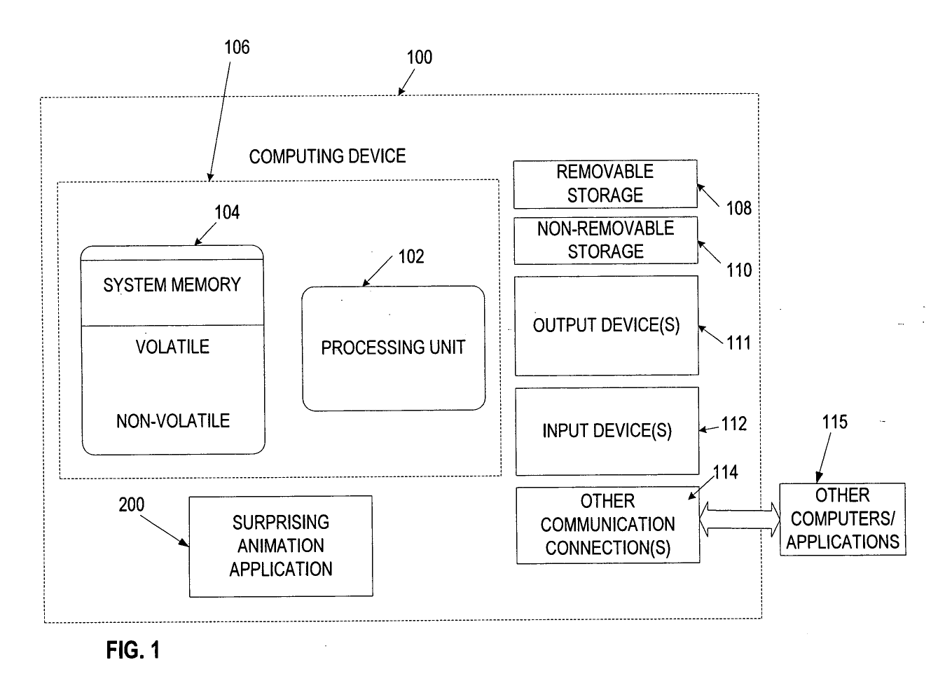

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

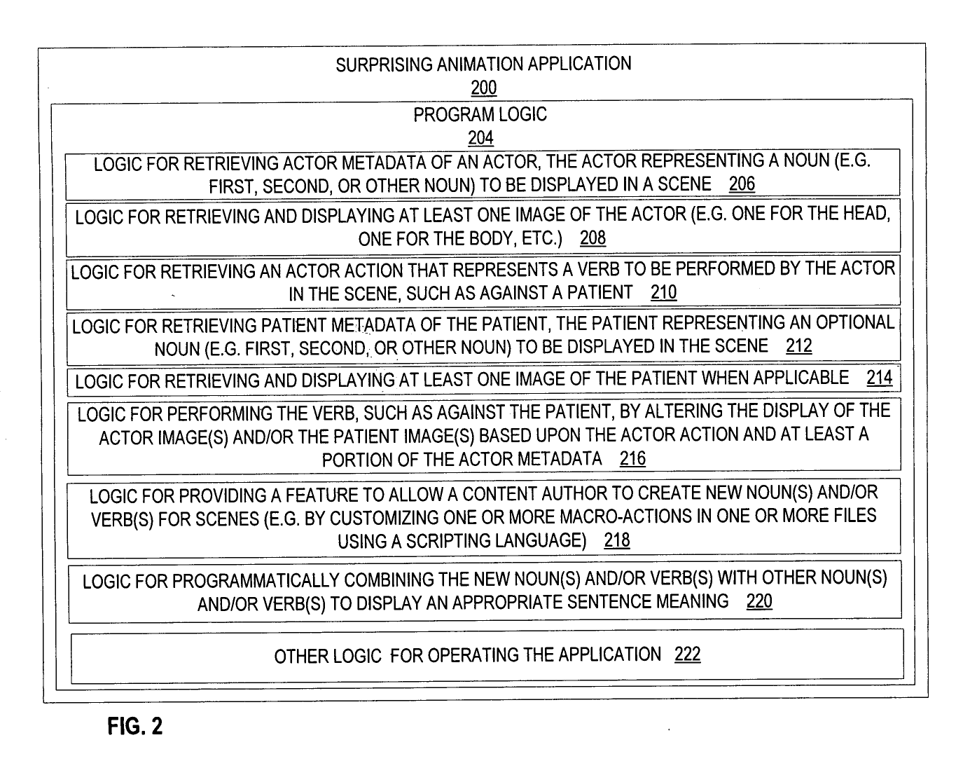

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes surprising animation application 200. Surprising animation application 200 will be described in further detail in FIG. 2.

Turning now to FIG. 2 with continued reference to FIG. 1, a surprising animation application 200 operating on computing device 100 is illustrated. Surprising animation application 200 is one of the application programs that reside on computing device 100. However, it will be understood that surprising animation application 200 can alternatively or additionally be embodied as computer-executable instructions on one or more computers and/or in different variations than shown on FIG. 1. Alternatively or additionally, one or more parts of surprising animation application 200 can be part of system memory 104, on other computers and/or applications 115, or other such variations as would occur to one in the computer software art.

Surprising animation application 200 includes program logic 204, which is responsible for carrying out some or all of the techniques described herein. Program logic 204 includes logic for retrieving actor metadata of an actor, the actor representing a noun (e.g. first, second, or other noun) to be displayed in a scene 206; logic for retrieving and displaying at least one image of the actor (e.g. one for the head, one for the body, etc.) 208; logic for retrieving an actor action that represents a verb to be performed by the actor in the scene, such as against the patient 210; logic for retrieving patient metadata of the patient, the patient representing an optional noun (e.g. first, second, or other noun) to be displayed in the scene 212; logic for retrieving and displaying at least one image of the patient where applicable 214; logic for performing the verb, such as against the patient, by altering the display of the actor images and/or the patient image(s) based upon the actor action and at least a portion of the actor metadata 216. In one implementation, surprising animation application 200 also includes logic for providing a feature to allow a content author to create new noun(s) (e.g. by providing at least one image and metadata) and/or verb(s) for scenes (e.g. by customizing one or more macro-actions in one or more files using a scripting language) 218; logic for programmatically combining the new noun(s) and/or verb(s) with other noun(s) and/or verb(s) to display an appropriate sentence meaning 220; and other logic for operating the application 222.

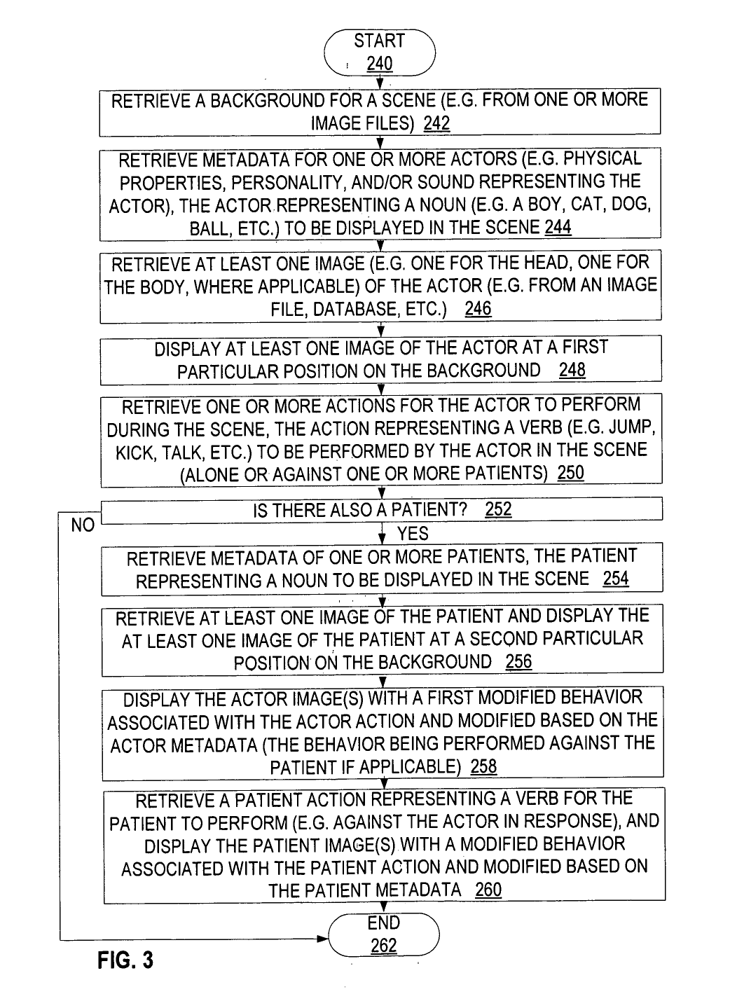

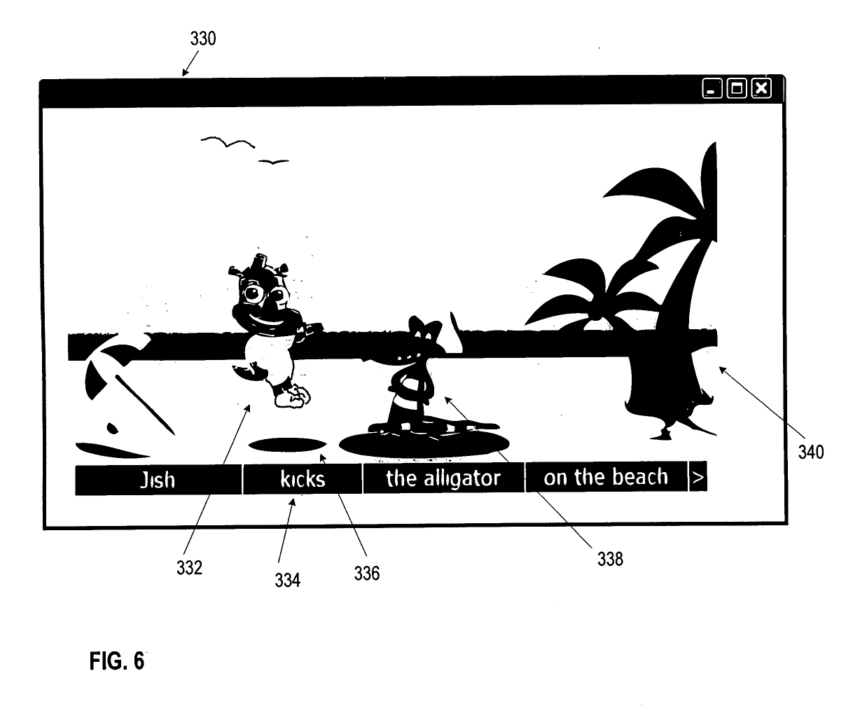

Turning now to FIGS. 3-5 with continued reference to FIGS. 1-2, the stages for implementing one or more implementations of surprising animation application 200 are described in further detail. Some more detailed implementations of the stages of FIGS. 3-5 are then described in FIG. 6-16. The stages described in FIG. 3 and in the other flow diagrams herein can be performed in different orders than they are described. FIG. 3 is a high level process flow diagram for surprising animation application 200. In one form, the process of FIG. 3 is at least partially implemented in the operating logic of computing device 100.

The procedure begins at start point 240 with retrieving a background for a scene, such as from one or more image files (stage 242). The term file as used herein can include information stored in a physical file, database, or other such locations and/or formats as would occur to one of ordinary skill in the software art. Metadata is retrieved for one or more actors (e.g. physical properties, personality, sound representing the actor, and/or one or more image filenames for the actor) (stage 244). An actor represents a noun (e.g. a boy, cat, dog, ball, etc.) to be displayed in the scene (stage 244). At least one image (e.g. a static image or animation) of the actor is retrieved (e.g. one for the head, one for the body, where applicable) from an image file, database, etc. (stage 246). In one implementation, the one or more images are retrieved by using the image filename(s) contained in the metadata to then access the physical file. The at least one image of the actor is displayed at a first particular position on the background (stage 248). The system retrieves one or more actions for the actor to perform during the scene, the action representing a verb (e.g. jump, kick, talk, etc.) to be performed by the actor alone or against one or more patients (stage 250). In one implementation, a verb is an action represented by one or more macro-actions. As one non-limiting example, a verb or action called “kick” may have multiple macro-actions to be performed to move the actor or patient to a different position, and to perform the kick movement, etc.

If there are also one or more patients to be represented in the scene (decision point 252), then the system retrieves metadata for the patient(s) (stage 254). A patient represents a noun (e.g. first, second, or other) to be displayed in the scene (stage 254). At least one image of the patient (e.g. a static image or animation) is retrieved and displayed at a second particular position on the background (stage 256). The actor image(s) are displayed with a first modified behavior associated with the actor action and modified based on the actor metadata (stage 258). The behavior is performed against the patient if the patient is present and/or if applicable (stage 258). If the patient is present, then a patient action representing a verb for the patient to perform is retrieved, and the patient image(s) are then displayed with a modified behavior associated with the patient action and modified based on the patient metadata (stage 260). In one implementation, the patient action is performed against the actor in response to the actor action that was performed against the patient (stage 260). The process ends at end point 262.

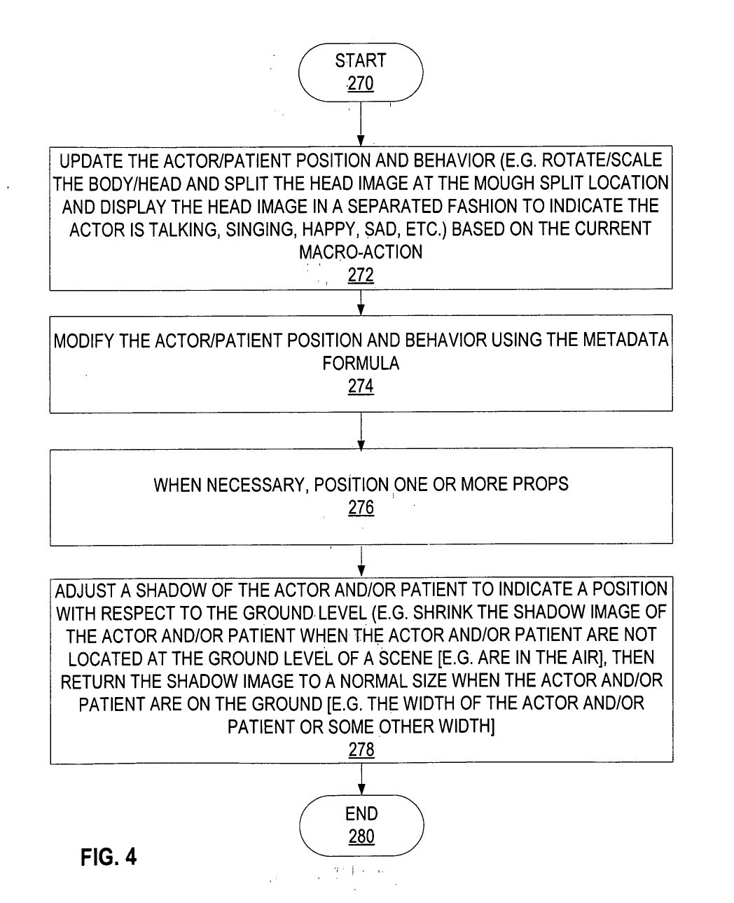

FIG. 4 illustrates one implementation of the stages involved in updating the position of the image(s) of the actor and/or patient based on the current macro-action and metadata information. In one form, the process of FIG. 4 is at least partially implemented in the operating logic of computing device 100. The procedure begins at start point 270 with updating a position and/or behavior of the image(s) of the actor and/or patient based on the current macro-action for the updated behavior (stage 272). As one non-limiting example, the position, size, rotation, color filter, and/or other aspects of a head image and a position, size, rotation, color filter and/or other aspects of the body image can be changed to provide an animation of the actor (stage 272). When applicable, a mouth split attribute associated with the image containing the head is retrieved. The attribute indicates a location of a mouth split for the actor within the particular image. As one non-limiting example, the head image can be split at the mouth split location so the head can be displayed in a separated fashion to indicate the actor is talking, singing, happy, sad, etc. (stage 272). The actor/patient position and behavior is modified by the metadata formula (stage 274). When necessary, a prop is selected to be displayed near the actor and/or patient (stage 276). For example, the action “love” could display a “heart” or “flower” prop or burst next to the actor with a corresponding sound effect at one point of the action (e.g. a special macro-action allowing for display of a prop/burst and for playing sound effect). Finally a shadow position and size is adjusted to illustrate the location of an actor and/or patient with respect to a ground level (stage 278). As one non-limiting example, when the actor and/or patient are located on the ground level, the shadow image size is kept at the same width as the actor and/or patient or some other width. When the actor and/or patient are not located at the ground level of a scene (e.g. are in the air), then the system shrinks the shadow image size of the actor and/or patient to a size smaller than the width of the actor and/or patient. The process ends at end point 280.

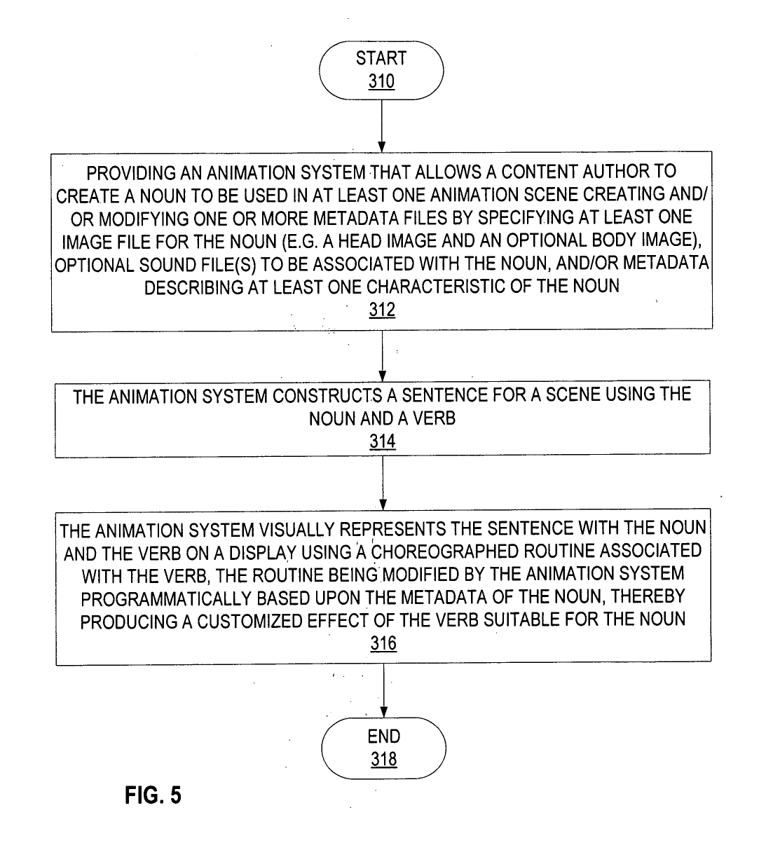

FIG. 5 illustrates one implementation of the stages involved in providing a customizable animation system that allows a user to create and/or modify nouns and/or verbs. In one form, the process of FIG. 5 is at least partially implemented in the operating logic of computing device 100. The procedure begins at start point 310 with providing an animation system that allows a content author to create a noun to be used in at least one animation scene by creating and/or modifying a metadata file for specifying at least one image file for the noun (e.g. a head image and an optional body image), optional sound file(s) to be associated with the noun, and/or metadata describing at least one characteristic of the noun (stage 312). The animation system constructs a sentence for a scene using the noun and a verb (stage 314). The animation system visually represents the sentence with the noun and the verb on a display using a choreographed routine associated with the verb, with the routine being modified by the animation system programmatically based upon the metadata of the noun, thereby producing a customized effect of the verb suitable for the noun (stage 316). Similar stages can be used for creating a new verb, only one or more action files would be created or modified instead of a metadata file. The process ends at end point 318.

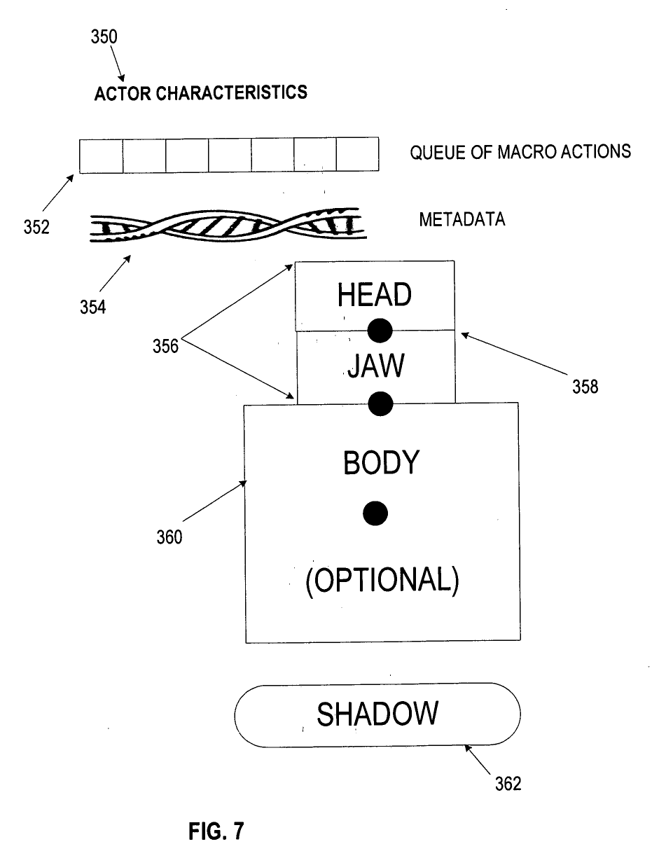

Turning now to FIGS. 6-16, more detailed explanations of an animation system 200 of one implementation that programmatically converts text to animation for representing sentence meaning is shown. FIG. 6 is a simulated screen 330 for one implementation of the system of FIG. 1 that illustrates a programmatically generated animation to represent sentence meaning. In the example shown, a sentence 334 is displayed as “Jish kicks the alligator on the beach” beneath the animated scene. In the scene, the character Jish 332 is shown to represent the first noun (e.g. the actor), “kicks” is the verb, and the character alligator 338 is shown to represent the second noun (e.g. the patient). Shadows are used underneath the characters (332 and 338) to represent whether or not the character is on the ground. For example, the character Jish 332 is in the air at the moment, so the shadow is smaller than his width. The scene is taking place on the beach, and a beach image 340 is shown as the background. As described in further detail in FIGS. 7-16, animation system 200 of one implementation is operable to generate various combinations of sentences such as 334 on FIG. 6 programmatically, and/or in a manner that is customizable by a content author without recompiling a program.

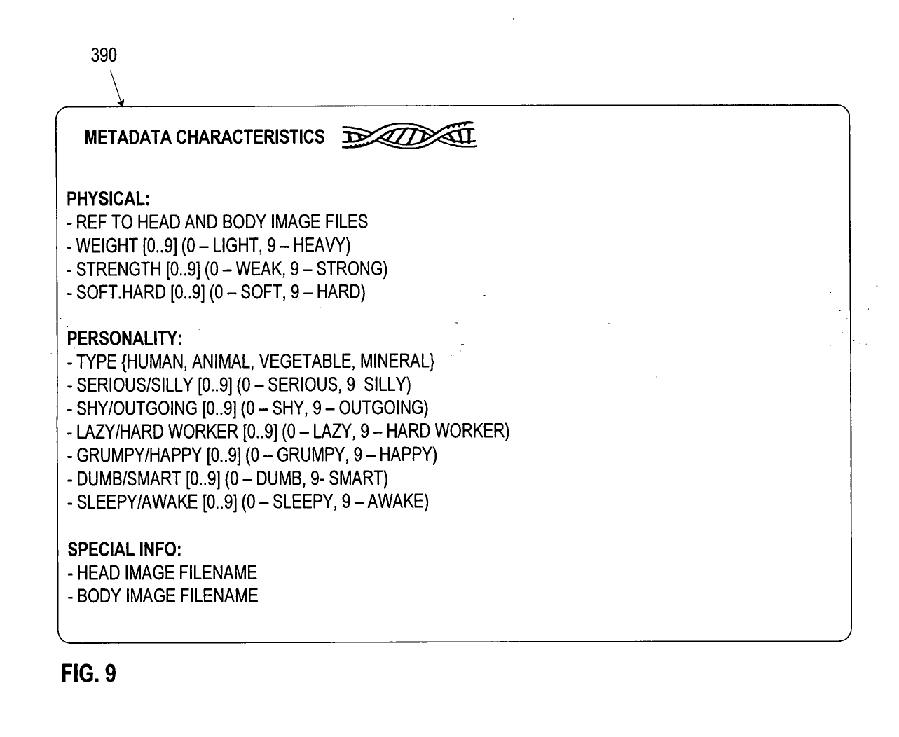

FIG. 7 is a logical diagram representing actor characteristics 350, and indicating how the images for an actor and/or patient are represented in one implementation prior to application of any movement. In one implementation, actor characteristics 350 include a queue of macro actions 352 that are to be performed by the actor and/or patient during the scene. In one implementation, a separate queue is used for the actor versus the patient. In another implementation, the same queue can be used to hold the various actions to be performed by the actor and the patient during a scene, with additional logic being involved to distinguish between those for the actor and those for the patient. The actor characteristics 350 also include metadata 354 for the actor and/or patient. In one implementation, the metadata 354 describes the physical properties, personality, image filename(s) of the actor, and/or sounds representing the actor and/or patient, as shown in further detail in FIG. 9.

In one implementation, each actor and/or patient includes a head image 356 and an optional body image 360. A ball, for example, might only have a head and not a body. A person, on the other hand, might have a head and a body. While the examples discussed herein illustrate a head and an optional body, it will be appreciated that various other image arrangements and quantities could also be used. As one non-limiting example, the head could be optional and the body required. As another non-limiting example, there could be a head, a body, and feet, any of which could be optional or required. As another non-limiting example, there could be just a single image representing a body. Numerous other variations for the images are also possible to allow for graphical representation of actors and/or patients. In one implementation, a shadow 362 is included beneath the actor and/or patient to represent a location of the actor and/or patient with respect to the ground.

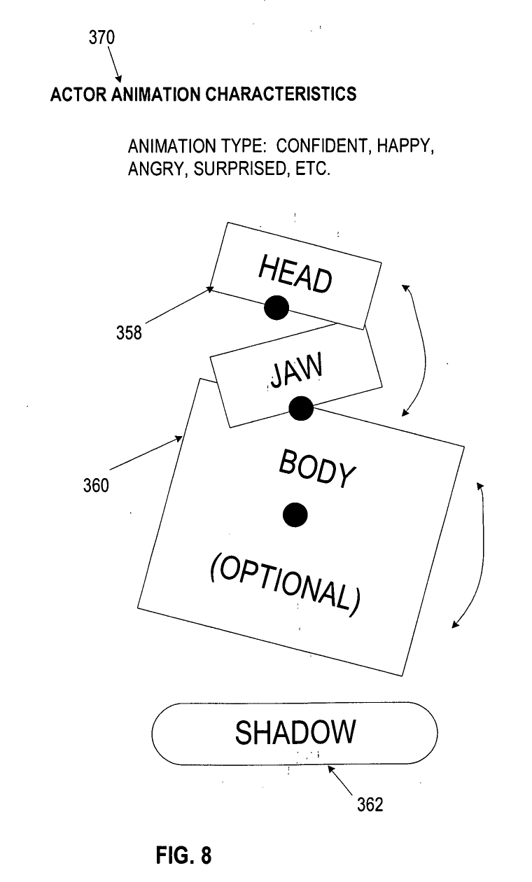

In one implementation, the head image 356 also includes an attribute that indicates a mouth split location 358. As shown in further detail in FIG. 8, the mouth split attribute 358 can be used to further split the head image into two or more pieces to illustrate mouth movement of the actor and/or patient, such as talking, singing, etc. While a mouth split is used in the examples discussed herein, other types of splits could alternatively or additional be used to indicate locations at which to separate an image for a particular purpose (to show a particular type of movement, for example).

FIG. 8 represents the effect of animation characteristics on an actor or patient, and visually indicates how the images for the actor and/or patient are represented in one implementation to apply movement. The head image is separated into two pieces based upon the mouth split 358. The head, jaw, and body image 360 are each rotated to indicate movement of the actor and/or patient. Shadow 362 is adjusted as appropriate. In one implementation, the images for the head and/or body are positioned, rotated, scaled, and/or colored (color filter) when modifying the behavior for the macro action being performed based upon the actor and/or patient metadata.

FIG. 9 is a logical diagram representing metadata characteristics 390, showing some exemplary metadata values that could be used to describe an actor and/or patient in one implementation. Examples of metadata include physical characteristics, personality, and/or special info such as head image filename and/or body image filename of the actor and/or patient. In the examples shown in FIG. 9, numbers from 0 to 9 are used to indicate some of the particular characteristics, such as for strength, 0 meaning weak at the lowest end and 9 meaning strong at the highest end. One of ordinary skill in the computer software art will appreciate that numerous other variations for specifying these characteristics could also be used in other implementations, such as letters, numbers, fixed variables, images, and/or numerous other ways for specifying the characteristics.

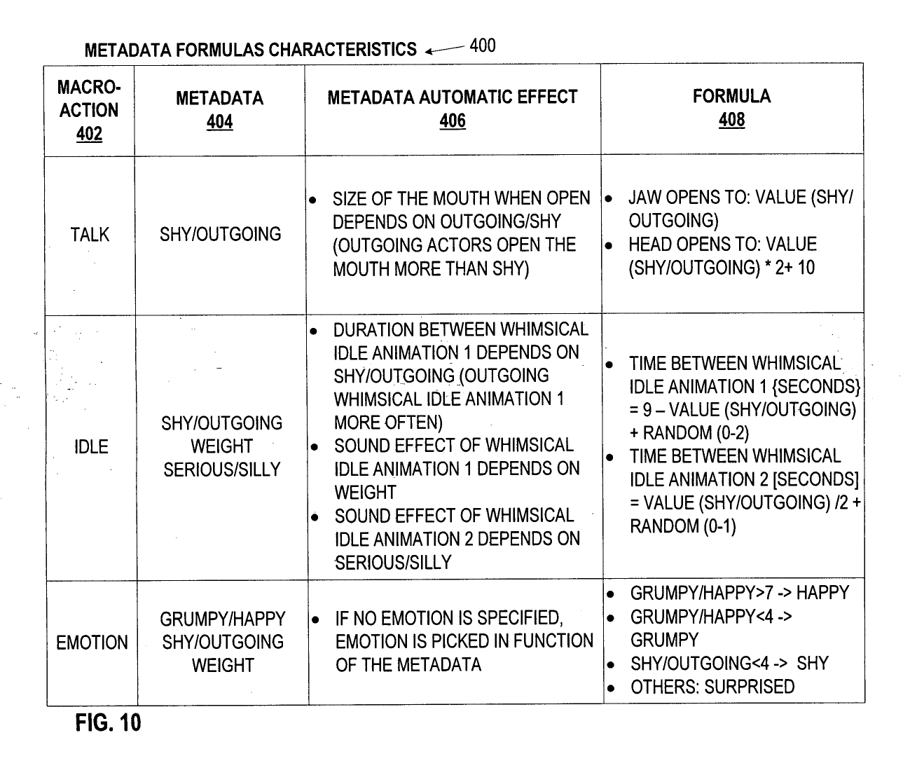

FIG. 10 is a logical diagram representing metadata formulas characteristics 400, and indicating some exemplary formulas that are based upon particular macro-actions and modified by metadata of an actor and/or patient in one implementation. For example, the macro-action 402 talk, consumes metadata 404 of shy versus outgoing, the metadata automatic effect 406 changes the size of the mouth when it is open depending on how shy versus outgoing the actor is. The formula(s) for talk when the actor has a shy/outgoing attribute plug in the value of the shy/outgoing attribute and then opens the jaw and places the head accordingly based upon the formula results. Notice that the examples of metadata formula 408 were based on metadata values between 0-9. In one implementation, the formula uses metadata to pick a type of emotion, such as happy, grumpy, shy, etc.

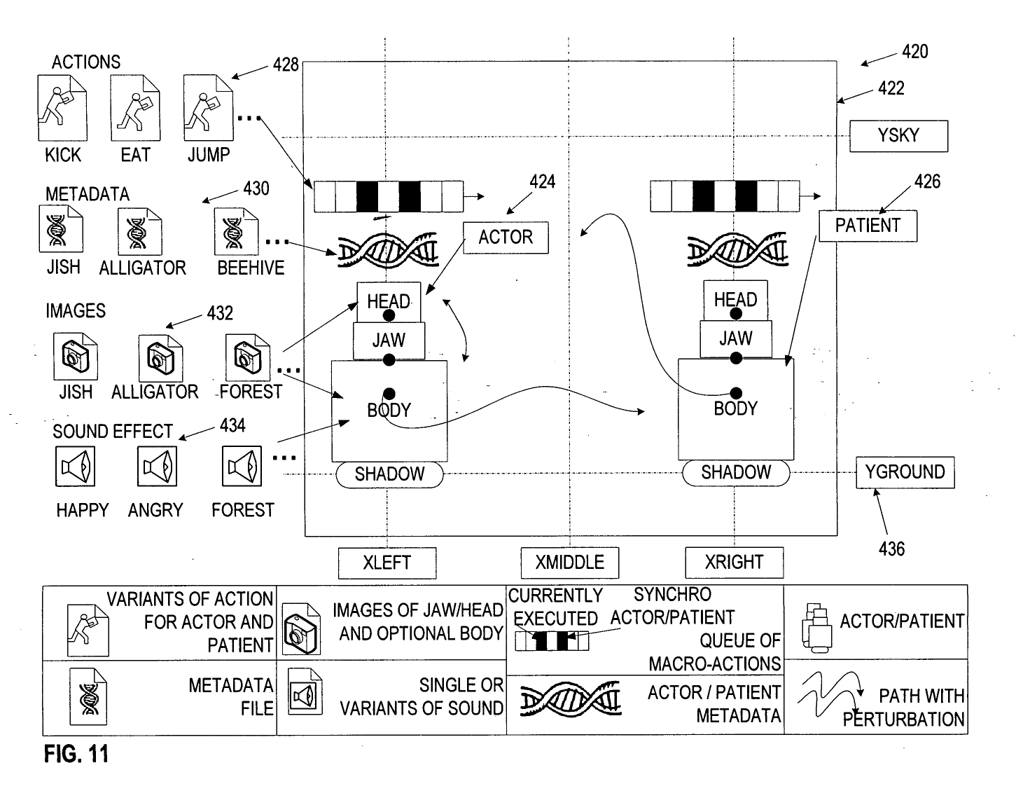

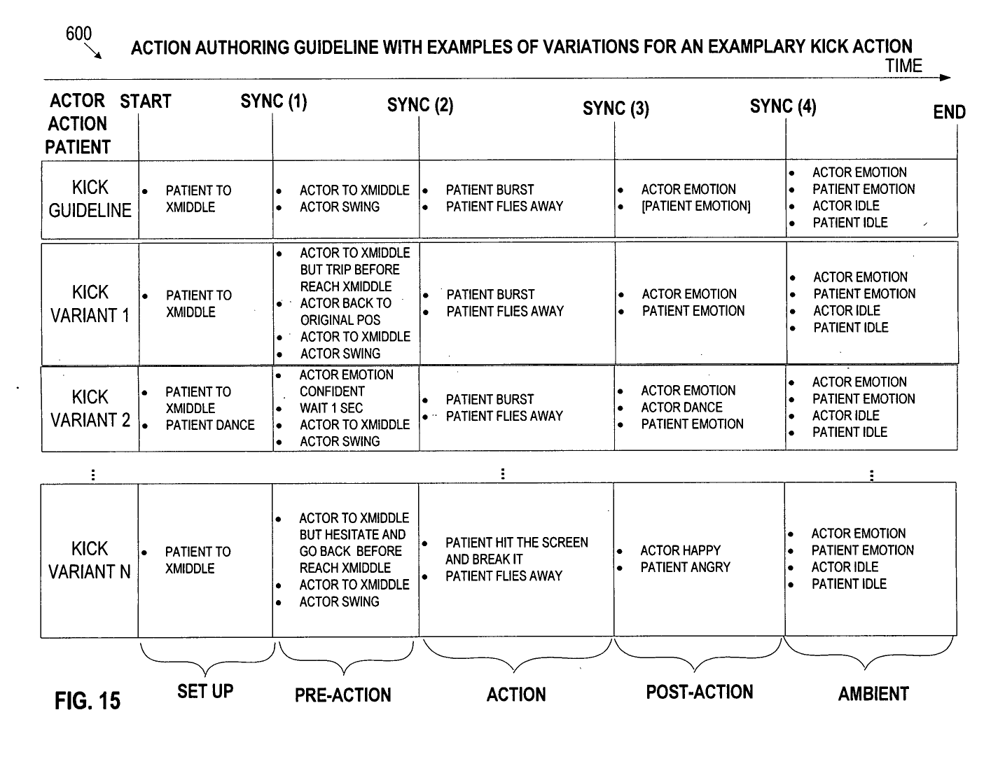

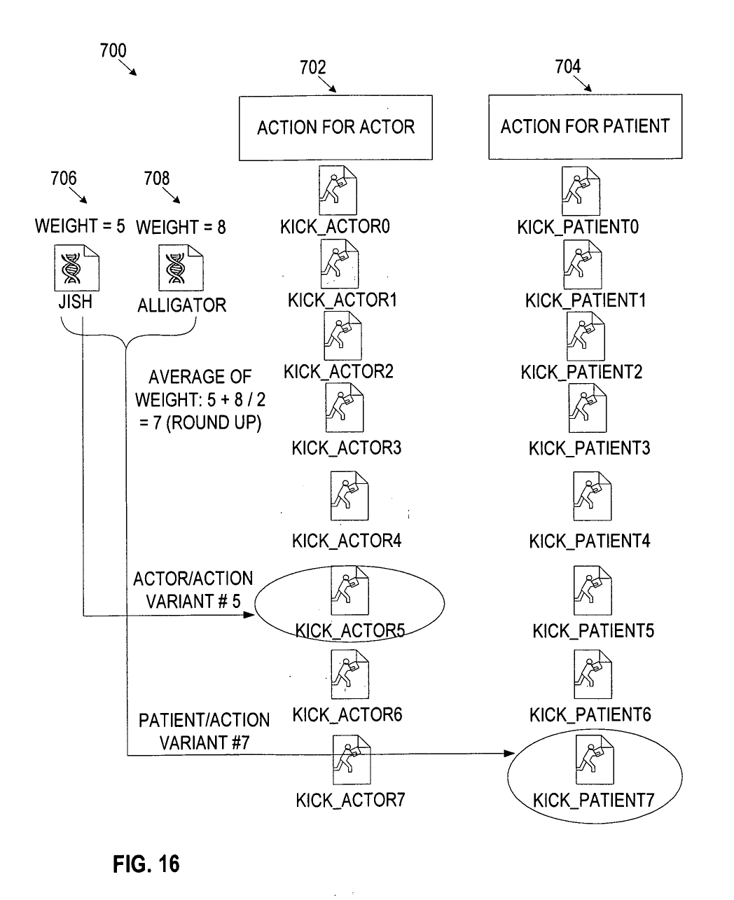

FIG. 11 is a logical diagram representing how a scene 420 is constructed from component parts in one implementation. Scene contains a background 422, which displays the actor 424 and the patient 426. The actions 428 feed into the macro-action queue of the actor and/or patient appropriately. While the example shows a single variation for each action, there can also be multiple variations of a particular action. The concept of multiple variations per action is illustrated in further detail in FIGS. 15 and 16. The metadata 430 for the actor 424 and/or the patient 426 are used to determine how to modify the actions 428 in a customized fashion based upon the personality and/or other characteristics of the actor and/or patient. The images 432 are used to construct the scene, such as an image being placed in the background 422, image(s) placed on the head/jaw and body of the actor and patient, etc. Sound effects 434 are played at the appropriate times during the scene.

The various locations on the background within the scene, such as yground 436, xleft, xmiddle, xright, and ysky are used to determine placement of the actor and/or patient. These various locations are also known as a landmark. In one implementation, these positions can be adjusted based on a particular background 422 so that the offsets can be appropriate for the particular image. For example, if a particular image contains a mountain range that takes up a large portion of the left hand side of the image, a content author may want to set the xmiddle location at a point further right that dead center, so that the characters will appear on land and not on the mountains.

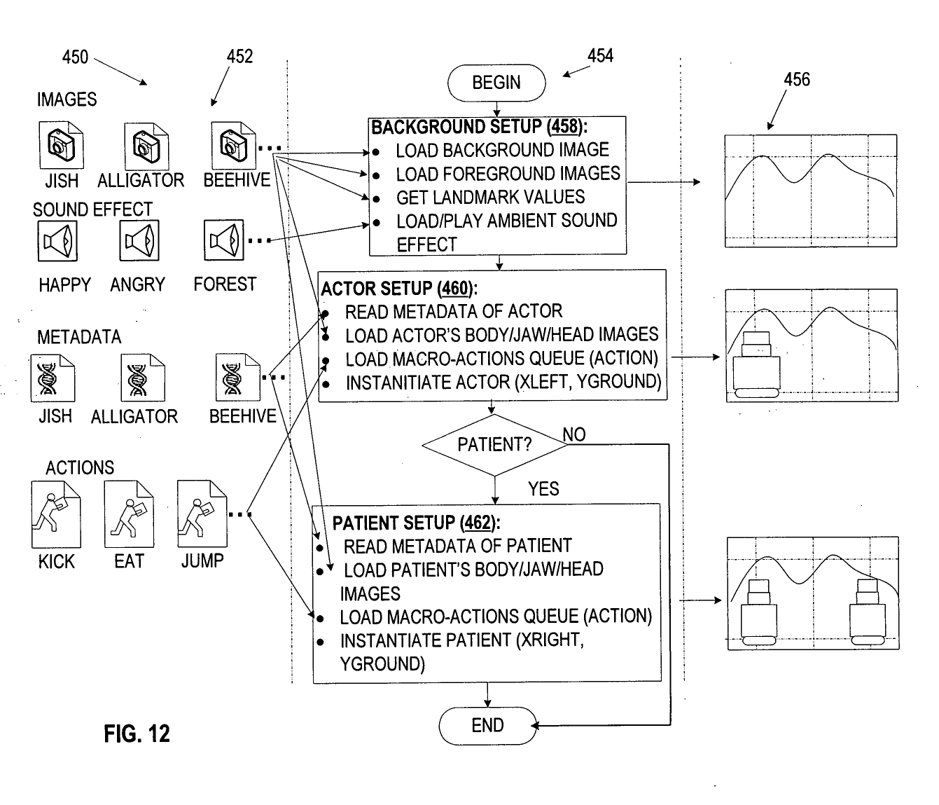

FIG. 12 is a logical diagram 450 with a flow diagram 454 to illustrate the stages of constructing a scene 456 from component parts 450 in one implementation. The images, sound effects, metadata, and actions are fed into the process 454 at various stages. In one form, process 454 is at least partially implemented in the operating logic of computing device 100. The scene construction begins with setting up the background (stage 458). Background images are loaded, foreground images are loaded, landmark values are retrieved, and/or ambient sound effects are loaded/played as appropriate. At this point, the scene 456 just displays the background image. The actor is then setup for the scene (stage 460). The metadata of the actor is retrieved, the actor's body/jaw/head images are loaded, the actor's macro-actions queue is loaded with one or more macro-actions to be performed by the actor during the scene, and the actor is instantiated on the background in the scene, such as xleft, yground (left position on the ground). At this point, the actor is displayed in the scene 456. The patient is then setup for the scene (stage 462).

The metadata of the patient is retrieved, the patient's body/jaw/head images are loaded, the macro-actions queue is loaded with one or more macro-actions to be performed by the patient during the scene, and the patient is instantiated on the background in the scene, such xright, yground (right position on the ground). At this point, the patient is displayed in the scene 456. In one implementation, the actor is on the left side and the patient is on the right side because the sentence represents the actor first to show the action being performed, and thus the actor appears first on the screen. As one non-limiting example, this kind of initial positioning might be convenient for some basic English sentences having an actor, action, patient, and background, but other initial positions could apply to other scenarios and/or languages. Furthermore, some, all, or additional stages could be used and/or performed and/or in a different order than described in process 454.

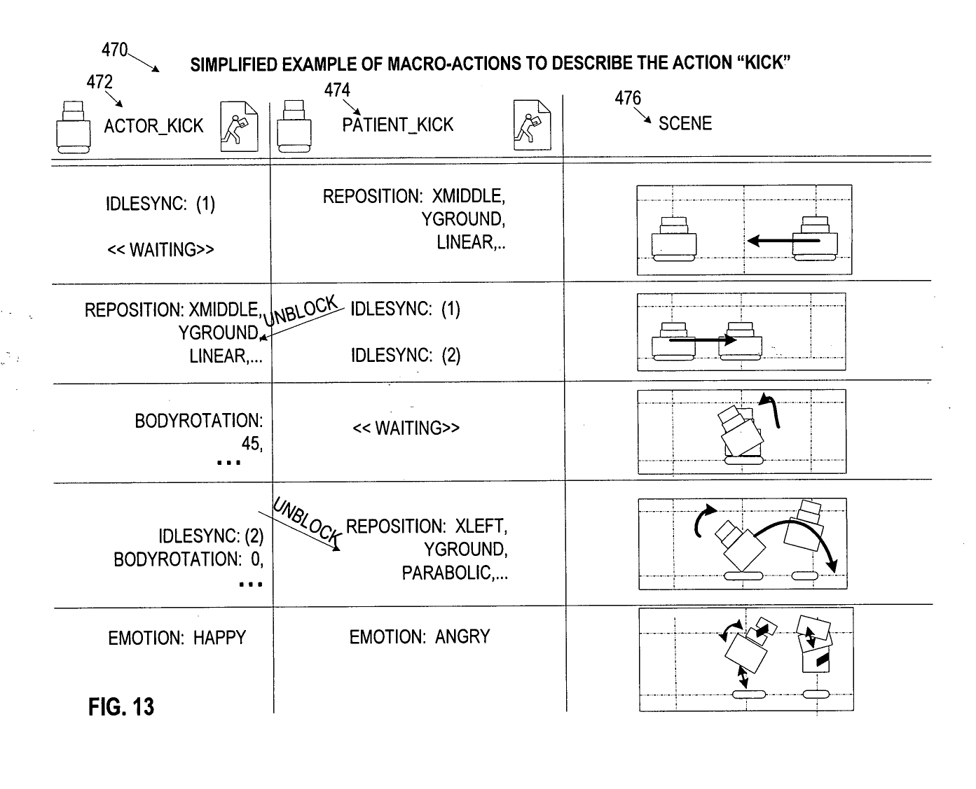

FIG. 13 is a logical diagram representing a simplified example of some exemplary macro-actions to describe an exemplary action “kick”. The actor 472 waits (and shows a whimsical idle animation that depends on its metadata) for the patient to move to the middle, as indicated by “<<waiting>>” in the top left column. The first caller (actor or patient) of the idlesync macro-action is waiting to be unblocked by another caller (actor or patient). Once the patient moves to the middle (as indicated by the “reposition” of the patient 474 in the top middle column), the actor 472 then repositions to the middle (xmiddle landmark) to perform the kick. As you can see from the various changes in the scene 476, the position of the actor and the patient is adjusted based on the action (e.g. the actor kick and the patient kick verbs being performed), as well as based upon the metadata (e.g. emotion) of the actor and the patient.

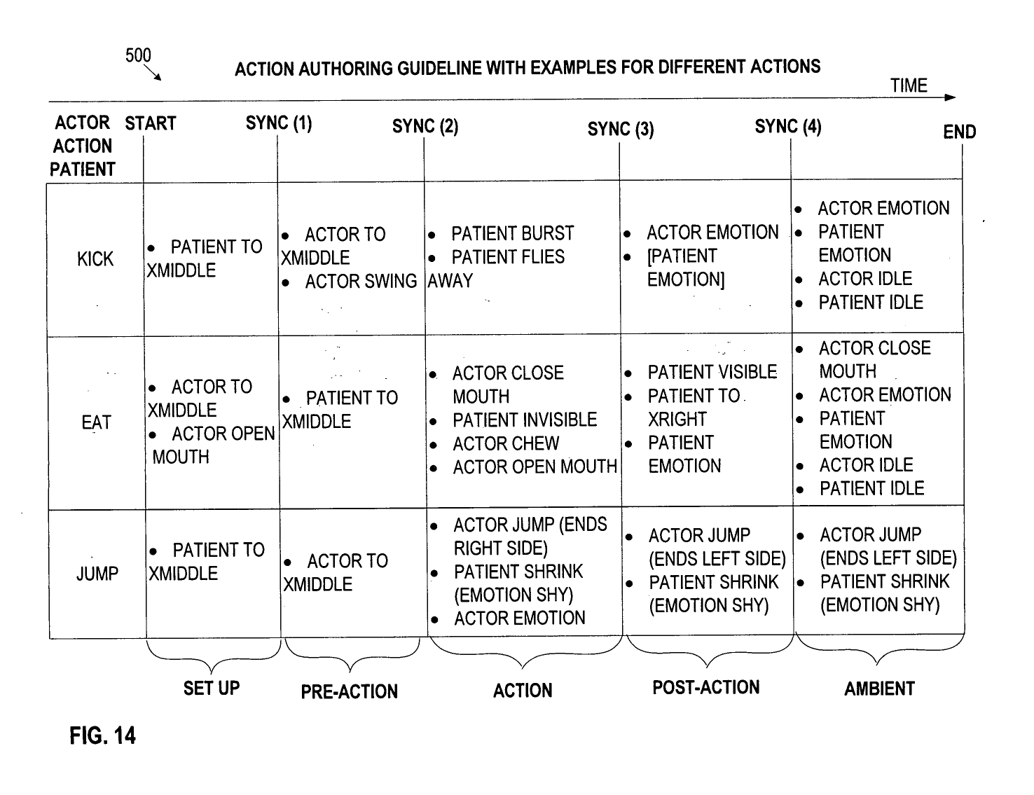

FIG. 14 is a logical diagram representing some exemplary action authoring guidelines 500 with example actions. Three example actions are shown in the figure, namely kick, eat, and jump. These are just for illustrative purposes, and numerous other actions could be used instead of or in addition to these. The authoring guideline for an action is used to specify what should happen at a particular point in time. For example, with a kick action, at the end of the first synchronization stage (set up stage), the patient should be at the xmiddle position before entering the next stage. At the end of the second synchronization stage (pre-action stage), the actor should be at the xmiddle position and should have performed a swing in order to illustrate a kick movement. This same idea applies similarly for all the following synchronization stages.

As shown in FIG. 15, with continued reference to FIG. 14, a logical diagram 600 illustrates that there can also be multiple variations of an action (in that example: also kick) that provide for customizations to the guidelines (adding/removing/changing macro-actions to the base guideline). These variations allow for surprising animations to occur because they can be selected based on some programmatic calculation involving metadata (e.g. a metadata formula to pick an action variant), etc. Note that with each variation in FIG. 15, at each synchronization point, the action being performed conforms to the guidelines. Without guidelines that use synchronization points, you might have an actor kicking dead air instead of the patient, an actor or patient waiting forever (never unblocked), and so on.

Continuing with the hypothetical example of the kick action, FIG. 16 is a logical diagram representing a selection of a particular variation of a kick action for the actor and patient based on metadata. In the example shown, there are multiple variations of the kick action for the actor 702, as well as multiple variations of kick actions for the patient 704. Using the metadata of the actor 706, the system chooses variation five, since the actor's weight is five (assuming that the metadata formula to pick an actor action variant is simply the weight metadata value of it between 0-9). In the example shown, a different metadata formula is used to pick the patient action variation for kick, which in this case is chosen by taking the average weight of the two (actor and patient) and then choosing that particular variation. Numerous types of formulas and/or logic could be used to determine which variation to choose to make the animations surprising and/or related to the metadata of the actors and/or patients.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for programmatically representing sentence meaning comprising the steps of:
retrieving actor metadata of an actor, the actor representing a noun to be displayed in a scene;
retrieving at least one image of the actor;
displaying the at least one image of the actor at a first particular position on the background;
retrieving an actor action for the actor to perform during the scene, the actor action representing a verb to be performed by the actor in the scene; and
displaying the at least one image of the actor with a first modified behavior, the first modified behavior being associated with the actor action and modified at least in part based on the actor metadata

2. The method of claim 1, wherein the actor metadata includes data selected from the group consisting of physical properties of the actor, personality properties of the actor, and a sound for audibly representing the actor.

3. The method of claim 1, wherein the at least one image of the actor is from at least one image file.

4. The method of claim 1, wherein the at least one image of the actor comprises a first image for a head of the actor and a second image for a body of the actor.

5. The method of claim 4, wherein a position of the first image and a position of the second image are adjusted when displaying the actor with the modified behavior associated with the actor action.

6. The method of claim 4, wherein the first image contains a mouth split attribute to indicate a location of a mouth split for the actor.

7. The method of claim 6, wherein the first image is displayed in an altered fashion at some point during the scene based on the mouth split attribute.

8. The method of claim 1, wherein a shadow image is placed underneath a location of the actor to indicate a position of the actor with respect to a ground level.

9. The method of claim 1, further comprising:
retrieving patient metadata of a patient, the patient representing another noun to be displayed in the scene;
retrieving at least one image of the patient; and
displaying the at least one image of the patient at a second particular position.

10. The method of claim 9, wherein the first modified behavior of the actor action is performed against the patient.

11. The method of claim 9, wherein the steps are repeated for a plurality of actors and patients.

12. The method of claim 9, further comprising:
retrieving a patient action for the patient to perform during the scene, the patient action representing a patient verb to be performed by the patient in the scene; and
displaying the at least one image of the patient with a second modified behavior, the second modified behavior being associated with the patient action and modified at least in part based on the patient metadata.

13. The method of claim 12, wherein the second modified behavior of the patient action is performed against the actor in response to the first modified behavior of the actor action performed against the patient.

14. A computer-readable medium having computer-executable instructions for causing a computer to perform the steps recited in claim 1.

15. A method for programmatically representing sentence meaning comprising the steps of:
providing an animation system that allows a content author to create a noun to be used in at least one animation scene by specifying at least one image file for the noun and metadata describing at least one characteristic of the noun;
wherein the animation system constructs a sentence for a scene using the noun and a verb; and
wherein the animation system visually represents the sentence with the noun and the verb on a display using a choreographed routine associated with the verb, the routine being modified by the metadata of the noun to produced a customized effect suitable for the noun.

16. The method of claim 15, wherein the at least one image of the noun comprises a first image for a head of the noun and a second image for a body of the noun.

17. A computer-readable medium having computer-executable instructions for causing a computer to perform steps comprising:
retrieve actor metadata of an actor, the actor representing a first noun to be displayed in a scene;
retrieve at least one image of the actor;
retrieve an actor action, the actor action representing a verb to be performed by the actor in the scene against a patient;
retrieve patient metadata of a patient, the patient representing another noun to be displayed in the scene;
retrieve at least one image of the patient;
display the at least one image of the actor;
display the at least one image of the patient; and
perform the verb against the patient by altering the display of the at least one image of the actor based upon the actor action and at least a portion of the actor metadata.

18. The computer-readable medium of claim 17, further having computer-executable instructions for causing a computer to perform steps comprising:
provide a feature to allow a content author to create a new noun; and
combine the new noun programmatically with at least one existing verb to display an appropriate sentence meaning based on inclusion of the new noun.

19. The computer-readable medium of claim 17, further having computer-executable instructions for causing a computer to perform steps comprising:
provide a feature to allow a content author to create a new verb; and
combine the new verb programmatically with at least one existing noun to display an appropriate sentence meaning based on inclusion of the new verb.

20. The computer-readable medium of claim 17, further having computer-executable instructions for causing a computer to perform steps comprising:
provide a feature to allow the scene to be customized by a content author, the feature allowing customizations to be performed by the content author using a scripting language to modify one or more files describing an operation of a background, the noun, and the verb.
